(19) United States
(12) Patent Application Publication
(10) Pub. No.: US 2015/0358594 A1
(43) Pub. Date: Dec. 10, 2015

(54) TECHNOLOGIES FOR VIEWER ATTENTION AREA ESTIMATION

(71) Applicants: Carl S. Marshall, Portland, OR (US); Amit Moran, Tel Aviv (IL)

(72) Inventors: Carl S. Marshall, Portland, OR (US); Amit Moran, Tel Aviv (IL)

(21) Appl. No.: 14/298,003

(22) Filed: Jun. 6, 2014

(51) Int. Cl. H04N 9/31; G06T 19/20; G06K 9/00; G09G 5/38; G06F 3/01; G06F 3/14

(52) U.S. Cl. CPC H04N 9/3194; G06F 3/013; G06F 3/1415; H04N 9/3182; G06K 9/00604; G09G 5/38; G06T 19/20; G09G 2300/026; G09G 2340/14; G09G 2340/0407; G09G 2340/045; G06T 2219/2016

(57) ABSTRACT

Technologies for viewer attention area estimation include a computing device to capture, by a camera system of the computing device, an image of a viewer of a display of the computing device. The computing device further determines a distance range of the viewer from the computing device, a gaze direction of the viewer based on the captured image and the distance range of the viewer, and an active interaction region of the display based on the viewer's gaze direction and the distance range of the viewer. The active interaction region is indicative of a region of the display at which the viewer's gaze is directed. The computing device displays content on the display based on the determined active interaction region.

### BACKGROUND

Digital signs are used to display information such as advertisements, notifications, directions, and the like to people near the signs. Unlike traditional billboard signs, the information displayed on a digital sign may be programmed to display particular content. For example, a digital sign may be programmed to display static content or to change the content displayed over time (e.g., displaying certain information one day and different information on a different day). Further, in some implementations, a person may interact with the digital sign to change the content shown on the digital sign (e.g., by virtue of the person's touch or gaze).

Businesses go to great efforts to understand what attracts a potential customer's attention (e.g., object colors, shapes, locations, sizes, orientations, etc.). Indeed, the cost of advertisement space is often dependent at least in part on the location and size (i.e., physical or virtual) of the advertisement. For example, locations at which persons frequently look tend to be in higher demand for advertisements than locations at which few persons look. Of course, myriad other tendencies of prospective customers are also monitored by businesses (e.g., travel patterns, etc.). In particular, various techniques have been employed to identify where persons are looking, which may be leveraged by businesses for any number of purposes (e.g., advertisement positioning, interactivity, and/or other reasons).

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for viewer attention area estimation by a computing device;

FIG. 2 is a simplified block diagram of at least one embodiment of an environment of the computing device of FIG. 1;

FIGS. 3-4 is a simplified flow diagram of at least one embodiment of a method for displaying viewer interactive content by the computing device of FIG. 1; and

FIGS. 5-7 are simplified illustrations of a viewer interacting with the computing device of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

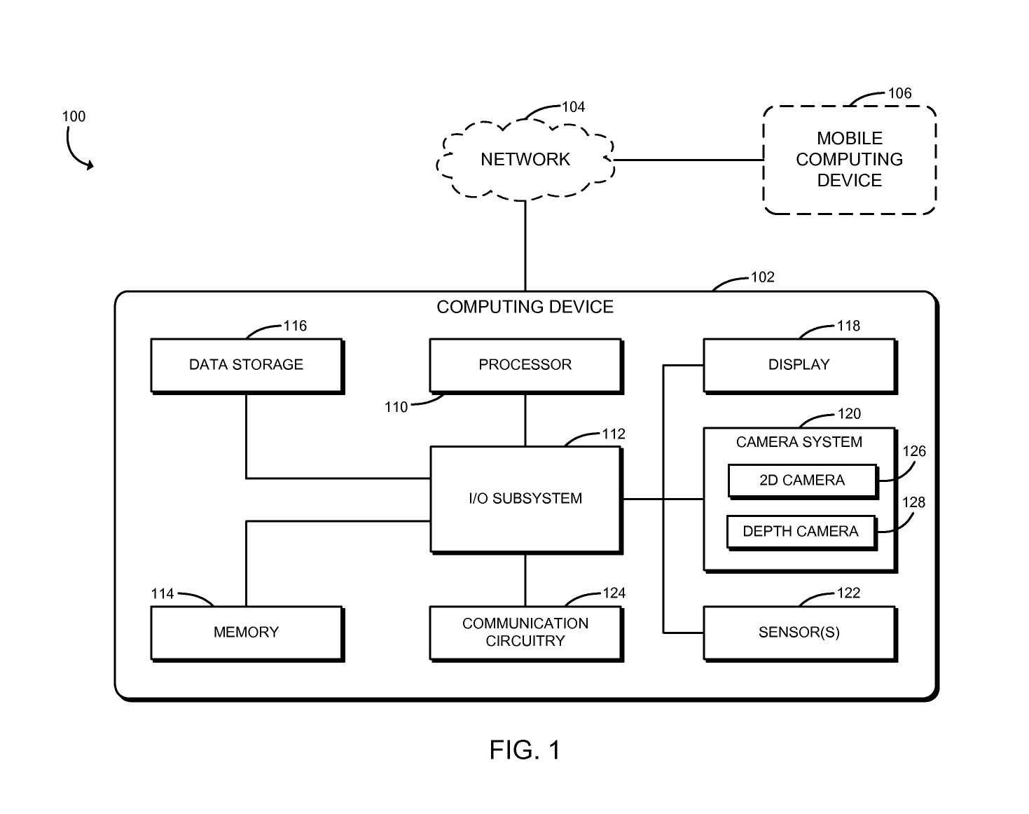

Referring now to FIG. 1, in the illustrative embodiment, a system 100 for estimating a viewer's attention area and displaying viewer interactive content includes a computing device 102 and may include one or more networks 104 and/or mobile computing devices 106. In use, as described in more detail below, the computing device 102 is configured to capture one or more images of a viewer of a display of the computing device 102 and determine the viewer's gaze direction based on an analysis of the captured images using a technology dependent on the distance of the viewer from the computing device 102. The computing device 102 is further configured to determine an active interaction region of the display based on the viewer's gaze direction and the viewer's distance and to display content on the display based on the determined active interaction region. In some embodiments, the system 100 may include a network 104 and a mobile computing device 106 (e.g., of the viewer), which enable the computing device 102 to perform various additional functions described herein. For example, in some embodiments, the computing device 102 may communicate with a mobile computing device 106 (i.e., via the network 104) of an identified viewer to facilitate determining the viewer's distance or approximate distance from the computing device 102.

The computing device 102 may be embodied as any type of computing device for displaying digital information to a viewer and capable of performing the functions described herein. It should be appreciated that, in some embodiments, the computing device 102 may be embodied as an interactive digital sign or another type of computing device having a large display. For example, in the illustrative embodiment, the computing device 102 is embodied as a “smart sign” that permits viewer/user interaction (i.e., with the sign itself) based on, for example, the viewer's gaze. Of course, depending on the particular embodiment, the computing device 102 may respond to various other types of viewer/user inputs (e.g., touch, audio, and other inputs). However, in some embodiments, the computing device 102 may not permit viewer interaction but may instead collect data regarding the viewer's gaze, which may be subsequently used, for example, to determine which region of the computing device 102 (i.e., which region of its display) drew most viewers' attention. Although only one computing device 102 is shown in the illustrative embodiment of FIG. 1, it should be appreciated that the system 100 may include multiple computing devices 102 in other embodiments. For example, in some embodiments, multiple computing devices 102 may cooperate with one another to display content and permit viewer interaction with the content based on the techniques described herein.

As indicated above, in some embodiments, the computing device 102 may communicate with one or more mobile computing devices 106 over the network 104 to perform the functions described herein. It should be appreciated that the mobile computing device(s) 106 may be embodied as any type of mobile computing device capable of performing the functions described herein. For example, the mobile computing device 106 may be embodied as a cellular phone, smartphone, wearable computing device, personal digital assistant, mobile Internet device, laptop computer, tablet computer, notebook, netbook, ultrabook, and/or any other computing/communication device and may include components and features commonly found in such devices. Additionally, the network 104 may be embodied as any number of various wired and/or wireless telecommunication networks. As such, the network 104 may include one or more networks, routers, switches, computers, and/or other intervening devices. For example, the network 104 may be embodied as or otherwise include one or more cellular networks, telephone networks, local or wide area networks, publicly available global networks (e.g., the Internet), or any combination thereof.

A shown in FIG. 1, the illustrative computing device 102 includes a processor 110, an input/output (“I/O”) subsystem 112, a memory 114, a data storage 116, a display 118, a camera system 120, one or more sensors 122, and a communication circuitry 124. Of course, the computing device 102 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component. For example, the memory 114, or portions thereof, may be incorporated in the processor 110 in some embodiments.

The processor 110 may be embodied as any type of processor capable of performing the functions described herein. For example, the processor 110 may be embodied as a single or multi-core processor(s), digital signal processor, microcontroller, or other processor or processing/controlling circuit. Similarly, the memory 114 of the computing device 102 may be embodied as any type of volatile or non-volatile memory or data storage capable of performing the functions described herein. In operation, the memory 114 may store various data and software used during operation of the computing device 102 such as operating systems, applications, programs, libraries, and drivers. The memory 114 is communicatively coupled to the processor 110 via the I/O subsystem 112, which may be embodied as circuitry and/or components to facilitate input/output operations with the processor 110, the memory 114, and other components of the computing device 102. For example, the I/O subsystem 112 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 112 may form a portion of a system-on-a-chip (SoC) and be incorporated, along with the processor 110, the memory 114, and/or other components of the computing device 102, on a single integrated circuit chip.

The data storage 116 may be embodied as any type of device or devices configured for short-term or long-term storage of data such as, for example, memory devices and circuits, memory cards, hard disk drives, solid-state drives, or other data storage devices. The data storage 116 and/or the memory 114 may store content for display and/or various other data useful during operation of the computing device 102 as discussed below.

The display 118 of the computing device 102 may be embodied as any type of display on which information may be displayed to a viewer of the computing device 102. Further, the display 118 may be embodied as, or otherwise use any suitable display technology including, for example, a liquid crystal display (LCD), a light emitting diode (LED) display, a cathode ray tube (CRT) display, a plasma display, an image projector (e.g., 2D or 3D), a laser projector, a touchscreen display, and/or other display technology. Although only one display 118 is shown in the illustrative embodiment of FIG. 1, in other embodiments, the computing device 102 may include multiple displays 118. For example, an image or video may be displayed across several displays 118 to generate a larger display format.

The camera system 120 may include one or more cameras configured to capture images or video (i.e., collections of images or frames) and capable of performing the functions described herein. It should be appreciated that each of the cameras of the camera system 120 may be embodied as any peripheral or integrated device suitable for capturing images, such as a still camera, a video camera, or other device capable of capturing video and/or images. As described below, the camera system 120 may capture images of viewers within the vicinity of the computing device 102 (e.g., in front of the computing device 102). In the illustrative embodiment, the camera system 120 includes a two-dimensional (2D) camera 126 and a depth camera 128.

The 2D camera 126 may be embodied as any type of two-dimensional camera. In some embodiments, the 2D camera 126 may include a RBG (red-green-blue) sensor or similar camera sensor configured to capture or otherwise generate images having three color channels (i.e., non-depth channels). Of course, the color values of the image may be represented in another way (e.g., as grayscale) and may include fewer or additional “color” channels. In some embodiments, depending on the particular type of 2D camera 126 and/or associated imaging technology, the RGB image color values of images generated by the 2D camera 126 may instead be represented as, for example, HSL (hue-saturation-lightness) or HSV (hue-saturation-value) values.

The depth camera 128 may be embodied as any device capable of capturing depth images or otherwise generating depth information for a captured image. For example, the depth camera 128 may be embodied as a three-dimensional (3D) camera, bifocal camera, a 3D light field camera, and/or be otherwise capable of generating a depth image, channel, or stream. In an embodiment, the depth camera 128 includes at least two lenses and corresponding sensors configured to capture images from at least two different viewpoints of a scene (e.g., a stereo camera). It should be appreciated that the depth camera 128 may determine depth measurements of objects in a scene in a variety of ways depending on the particular depth camera 128 used. For example, the depth camera 128 may be configured to sense and/or analyze structured light, time of flight (e.g., of signals), light detection and ranging (LIDAR), light fields, and other information to determine depth/distance of objects. Further, in some circumstances, the depth camera 128 may be unable to accurately capture the depth of certain objects in the scene due to a variety of factors (e.g., occlusions, IR absorption, noise, and distance). As such, there may be depth holes (i.e., unknown depth values) in the captured depth image/channel, which may be indicated as such with a corresponding depth pixel value (e.g., zero or null). Of course, the particular value or symbol representing an unknown depth pixel value in the depth image may vary based on the particular implementation.

The depth camera 128 is also configured to capture color images in the illustrative embodiment. For example, the depth camera 128 may have a RGB-D (red-green-blue-depth) sensor(s) or similar camera sensor(s) that may capture images having four channels—a depth channel and three color channels (i.e., non-depth channels). In other words, the depth camera 128 may have an RGB color stream and a depth stream. Alternatively, in some embodiments, the computing device 102 may include a camera (e.g., the 2D camera 126) having a sensor configured to capture color images and another sensor (e.g., one of the sensors 122) configured to capture object distances. For example, in some embodiments, the depth camera 128 (or corresponding sensor 122) may include an infrared (IR) projector and an IR sensor such that the IR sensor estimates depth values of objects in the scene by analyzing the IR light pattern projected on the scene by the IR projector. Further, in some embodiments, the color channels captured by the depth camera 128 may be utilized by the computing device 102 instead of capturing a separate image with a 2D camera 126 as described below. For simplicity, references herein to an “RGB image,” a “color image,” and/or a 2D image refer to an image based on the color/grayscale channels (e.g., from the RBG stream) of a particular image, whereas references to a “depth image” refer to a corresponding image based at least in part on the depth channel/stream of the image.

As shown in FIG. 1, the computing device 102 may include one or more sensors 122 configured to collect data useful in performing the functions described herein. For example, the sensors 122 may include a depth sensor that may be used to determine the distance of objects from the computing device 102. In various embodiments, the sensors 122 may be embodied as, or otherwise include, for example, proximity sensors, optical sensors, light sensors, audio sensors, temperature sensors, motion sensors, piezoelectric sensors, and/or other types of sensors. Of course, the computing device 102 may also include components and/or devices configured to facilitate the use of the sensor(s) 122.

The communication circuitry 124 may be embodied as any communication circuit, device, or collection thereof, capable of enabling communications between the computing device 102 and other remote devices over a network 104 (e.g., the mobile computing device 106). The communication circuitry 124 may be configured to use any one or more communication technologies (e.g., wireless or wired communications) and associated protocols (e.g., Ethernet, Bluetooth®, Wi-Fi®, WiMAX, etc.) to effect such communication.

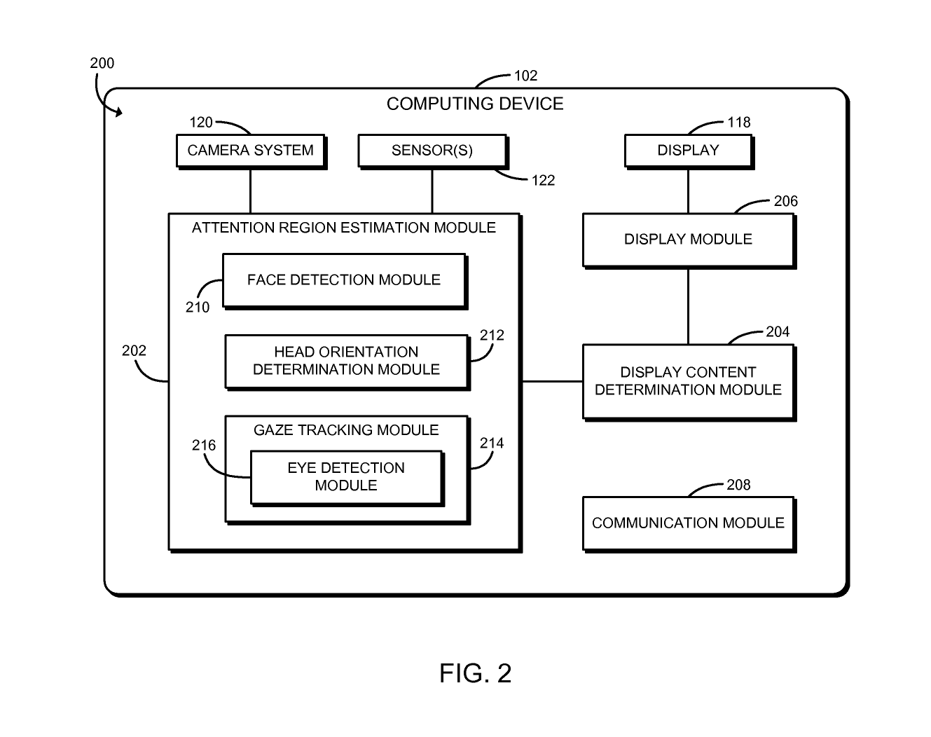

Referring now to FIG. 2, in use, the computing device 102 establishes an environment 200 for estimating a viewer's attention area and displaying viewer interactive content. As discussed below, the computing device 102 utilizes the camera system 120 to capture an image(s) of one or more viewers of the computing device 102 (i.e., persons looking at the display 118). Further, the computing device 102 determines a distance range of a viewer from the computing device 102, a gaze direction of the viewer (e.g., based on the captured image(s) and the distance range), and an active interaction region of the display 118 (e.g., based on the viewer's gaze direction and the distance range of the viewer). As described below, the distance range of the viewer from the computing device 102 may be determined as an absolute or approximate physical distance or be determined to fall within a range of distances (e.g., short range, mid-range, and long range). Further, the particular technology used to determine the gaze direction of the viewer may be based on, for example, the determined distance range of the viewer. As described below, the active interaction region is indicative of a region of the display 118 at which the viewer's gaze is directed. Additionally, in the illustrative embodiment, computing device 102 displays content, which may vary, on the display 118 based on the determined active interaction region.

The illustrative environment 200 of the computing device 102 includes an attention region estimation module 202, a display content determination module 204, a display module 206, and a communication module 208. Additionally, the attention region estimation module 202 includes a face detection module 210, a head orientation determination module 212, and a gaze tracking module 214. As shown, the gaze tracking module 214 further includes an eye detection module 216. Each of the modules of the environment 200 may be embodied as hardware, software, firmware, or a combination thereof. Additionally, in some embodiments, one or more of the illustrative modules may form a portion of another module. For example, the display content determination module 204 may form a portion of the display module 206 in some embodiments (or vice-versa).

The attention region estimation module 202 receives the images captured with the camera(s) of the camera system 120 (e.g., captured as streamed video or as individual images), analyzes the captures images, and determines a region of the display 118 at which a viewer's gaze is directed (i.e., an active interaction region). As discussed below, in the illustrative embodiment, the particular images captured by the camera system and/or utilized by the attention region estimation module 202 to make such a determination are dependent on the distance range of the viewer from the computing device 102. As such, the attention region estimation module 202 is configured to determine a distance range of the viewer relative to the computing device 102. To do so, the attention region estimation module 202 may analyze images captured by the camera system 120 and/or data collected by the sensors 122. Depending on the particular embodiment, the attention region estimation module 202 may determine the distance range of the viewer from the computing device 102 at any suitable level of granularity or accuracy. For example, the distance range may be embodied as an absolute physical distance (e.g., three feet), an approximate distance, or a range of distances (e.g., between three feet to ten feet). In the illustrative embodiment, the attention region estimation module 202 determines the viewer's distance from the computing device 102 by determining which one of a set of pre-defined distance ranges the viewer is currently located within. The distance ranges may be embodied as specific ranges of distances (e.g., zero to three feet, three feet to ten feet, etc.) or as abstract ranges (e.g., short range, mid-range, or long range). It should be appreciated that, depending on the particular embodiment, there may be any number of discrete distance ranges and any number of devices and/or technologies to detect range. For example, in some embodiments, there may be N distance ranges and N corresponding devices/technologies for range/distance detection, where N is a positive integer greater than one. Of course, in other embodiments, the number of distance ranges and the number of available range/distance technologies may differ. Further, in some embodiments, the attention region estimation module 202 may determine the distance range as an explicit step (e.g., using a depth or distance sensor), whereas in other embodiments, the distance range may be determine more implicitly (e.g., based on technology limitations, etc.) as described below. Of course, in some embodiments, the attention region estimation module 202 may not determine the distance range of a person from the computing device 102 until determining that the person is looking at the display 118 or in the general vicinity (e.g., in response to detecting the person's face in a captured image).

As discussed above, the physical distances constituting each distance range may depend on the particular embodiment. In some embodiments, the distance ranges may be defined according to predefined distances or thresholds. For example, short range may be between zero and four feet from the computing device 102, mid-range may be between four feet and fifteen feet, and long range may be greater than fifteen feet. In other embodiments, e distance ranges may be abstracted and based on the limitations of the technologies described herein. For example, as discussed below, gaze tracking algorithms may only be able to accurately determine the viewer's gaze direction within a threshold level of error (e.g., up to 10% error) up to a particular threshold distance. Similarly, the depth camera 128 or depth sensors may only be able to accurately measure depth of objects within an acceptable threshold level of error up to another threshold distance. Of course, it should be appreciated that the distance ranges may be selected based on other criteria in other embodiments (e.g., regardless of whether gaze tracking algorithms and/or depth camera 128 images provide accurate data). For example, in some embodiments, gaze tracking algorithms, depth camera 128 images, and/or RGB images may provide accurate results even at long ranges. In such embodiments, the distance ranges may be determined based on, for example, algorithmic and computational efficiency. That is, RGB image analysis may be used at long ranges, because it is most efficient and provides sufficient accuracy at such distances. Similarly, RGB-D image analysis may be used at mid-ranges and gaze tracking algorithms at short ranges. It should further be appreciated that the attention region estimation module 202 may determine gaze direction of the viewer and the active interaction region of the display 118 for multiple viewers of the computing device 102 in some embodiments.

As discussed above, the attention region estimation module 202 includes the face detection module 210, the head orientation determination module 212, and the gaze tracking module 214. The face detection module 210 detects the existence of one or more person's faces in a captured image and determines the location of any detected faces in the captured image. It should be appreciated that the face detection module 210 may utilize any suitable object detection/tracking algorithm for doing so. Further, in some embodiments, the face detection module 210 may identify a person based on their detected face (e.g., through biometric algorithms and/or other face recognition or object correlation algorithms). As such, in embodiments in which the gaze directions of multiple persons are tracked, the face detection module 210 may distinguish between those persons in the captured images to enhance tracking quality. In some embodiment, the face detection module 210 may detect the existence of a person in a captured image prior to detecting the location of that person's face.

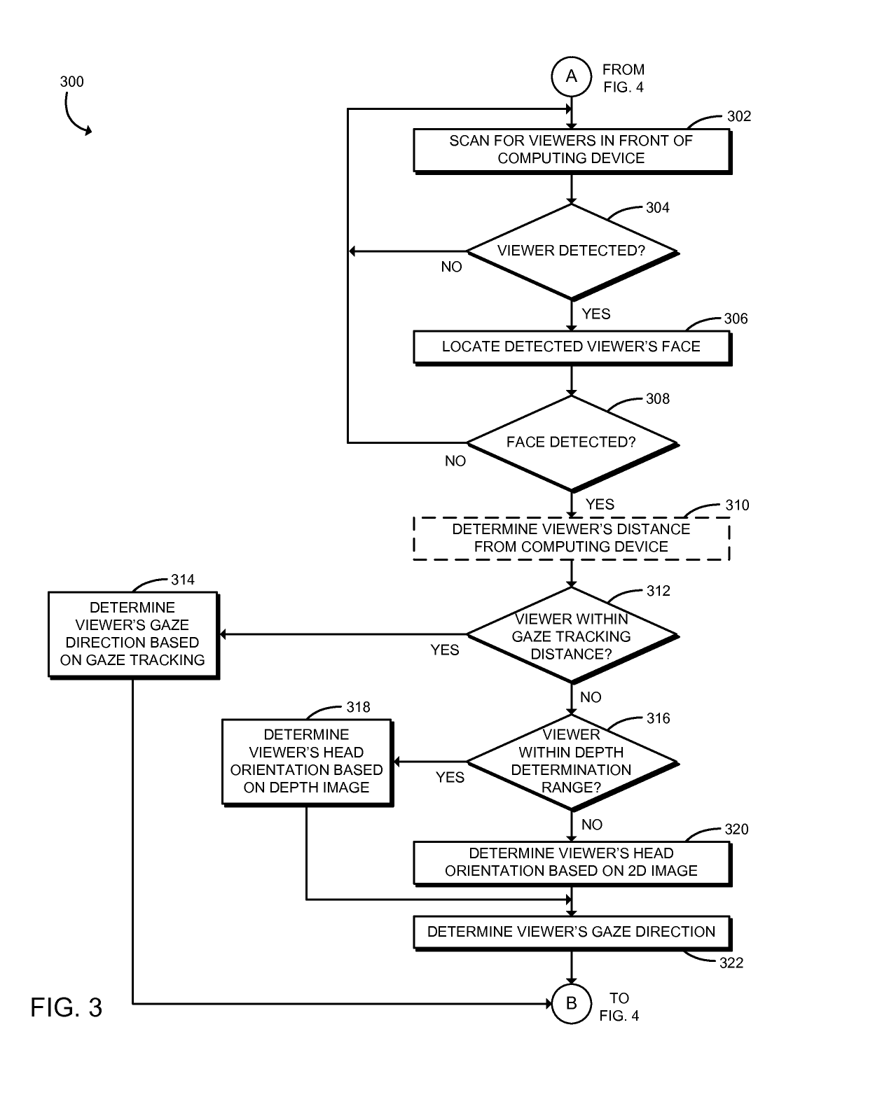

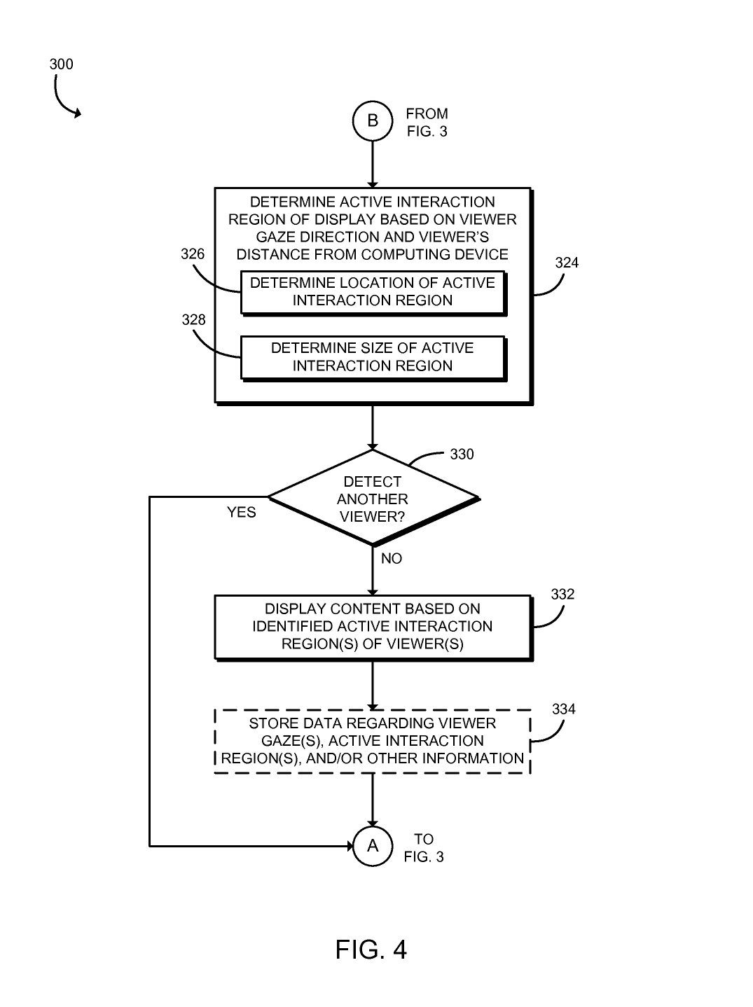

The head orientation determination module 212 determines a head pose of a viewer of the computing device 102 relative to the computing device 102. As discussed below in reference to FIG. 3, in the illustrative embodiment, the head orientation determination module 212 determines the viewer's head pose based on an image captured by the 2D camera 126 if the viewer is a long range from the computing device 102 and based on an image captured by the depth camera 128 if the viewer is a mid-range from the computing device 102. That is, in some embodiments, the head orientation determination module 212 may utilize both RGB and depth image pixel values at distances in which the depth values are available (e.g., mid-range distances) and default to RGB values when depth values are unavailable. Of course, the head orientation determination module 212 may utilize any suitable techniques and/or algorithms for determining the head pose/orientation of the viewer relative to the computing device 102. For example, in an embodiment, the head orientation determination module 212 may compare the viewer's head as shown in the captured image(s) to a collection of reference/model images of a person's head in various orientations.

The gaze tracking module 214 determines a gaze direction of the viewer based on, for example, the captured image(s) of the viewer (e.g., RGB images and/or RGB-D images) and the determined distance range of the viewer (e.g., short range, mid-range, or long range). It should be appreciated that the gaze tracking module 214 may utilize any suitable techniques and/or algorithms for doing so. For example, within close proximity to the computing device 102 (e.g., within a short range), the gaze tracking module 214 may utilize eye and gaze tracking algorithms to determine the gaze direction of the viewer (e.g., based on an analysis of captured image(s) of the viewer). Further, in the illustrative embodiment, the gaze tracking module 214 may determine the gaze direction of the viewer based on an analysis of an RGB-D image or analogous data when the viewer is within mid-range of the computing device 102 (e.g., when accurate depth information is available). In the illustrative embodiment, when the viewer is a long range from the computing device 102 (e.g., when accurate depth information is unavailable), the gaze tracking module 214 analyzes an RGB image (i.e., a captured image not including accurate depth information) to determine the gaze direction of the viewer. Although eye and gaze detection, tracking, and analysis may be discussed herein in reference to a single eye of the viewer for simplicity and clarity of the description, the techniques described herein equally apply to tracking both of the viewer's eyes.

The eye detection module 216 determines the location of the viewer's eye in the captured image and/or relative to the computing device 102. To do so, the eye detection module 216 may use any suitable techniques, algorithms, and/or image filters (e.g., edge detection and segmentation). In some embodiments, the eye detection module 216 utilizes the location of the viewer's face (i.e., determined with the face detection module 210) to determine the location of the viewer's eyes to, for example, reduce the region of the captured image that is analyzed to location the viewer's eye(s). Of course, in other embodiments, the eye detection module 216 may make a determination of the location of the viewer's eyes independent of or without a determination of the location of the viewer's face. Additionally, in some embodiments, the eye detection module 216 analyzes the viewer's eyes to determine various characteristics/features of the viewer's eyes (e.g., glint location, iris location, pupil location, iris-pupil contrast, eye size/shape, and/or other characteristics). It should be appreciated that the gaze tracking module 214 may utilize the various determined features of the viewer's eye for determining the viewer's gaze direction and/or location relative to the computing device 102. For example, in an embodiment, the gaze tracking module 214 uses glints (i.e., first Purkinje images) reflected off the cornea and/or the pupil of the viewer's eye for gaze tracking or, more particularly, glint analysis. Based on the reflections, the gaze tracking module 214 may determine the gaze direction of the viewer and/or the location or position (e.g., in three-dimensional space) of the viewer relative to the computing device 102.

It should be appreciated that, based on the determined gaze direction of the viewer, the attention region estimation module 202 is capable of determining an active interaction region of the display 118. For example, based on the gaze direction of the viewer and/or the distance range of the viewer, the attention region estimation module 202 may determine the region of the display 118 at which the viewer is focused. In other words, the display 118 may be divided into an active interaction region at which the viewer's gaze directed and the viewer may interact with the display 118 and a passive interaction region of the display 118 at which the viewer's gaze is not directed. In some embodiments, the passive interactive region may display complementary information. Further, in some embodiments, the size of the determined active interaction region may be determined based on the distance range of the viewer from the computing device 102. For example, in the illustrative embodiment, the size of the active interaction region is smaller when the viewer is a short range from the computing device 102 than when the viewer is a mid-range from the computing device 102. Similarly, the active interaction region is smaller when the viewer is a mid-range from the computing device 102 than when the viewer is a long range from the computing device 102. In such a way, the attention region estimation module 202 may dynamically determine the size and location of the active interaction region of the display 118 based on the viewer's gaze direction and the distance range of the viewer from the computing device 102. Further, as discussed below, the content displayed may similarly change such that, for example, as the viewer approaches the computing device 102, the amount of details provided by the content increases.

The display content determination module 204 determines content to display on the display 118 of the computing device 102 based on, for example, the determined active interaction region. As discussed above, in the illustrative embodiment, the viewer's gaze may be used an input. That is, the viewer's gaze direction may be indicative of a desired input selection of the viewer to the computing device 102. Accordingly, in such embodiments, the display content determination module 204 may select content for display based on the viewer's desired input selection (i.e., the viewer's gaze direction and/or the determined active interaction region). Further, as discussed above, the computing device 102 may be configured for use by multiple viewers. As such, in some embodiments, the display content determination module 204 may determine content for display based on the gaze directions and/or determined active interaction regions of multiple viewers. For example, the display content determination module 204 may give a particular viewer's interactions priority (e.g., the closest viewer to the computing device 102), perform crowd analysis to determine an average, median, mode, or otherwise collectively desired interaction, and/or determine content for display in another suitable manner. In an embodiment, the display content determination module 204 may determine to display content for one viewer in one region of the display 118 and other content for another viewer on another region of the display 118 (e.g., if the corresponding active interaction regions of the viewers do not overlap).

The display module 206 is configured to display content (i.e., determined by the display content determination module 204) on the display 118 of the computing device 102. As discussed above, in the illustrative embodiment, the content displayed on the display 118 is based, at least in part, on a determined active interaction region of one or more viewers of the display 118.

The communication module 208 handles the communication between the computing device 102 and remote devices (e.g., the mobile computing device 106) through the corresponding network (e.g., the network 104). For example, in some embodiments, the computing device 102 may communicate with the mobile computing device 106 of a viewer to accurately determine the viewer's distance relative to the computing device 102 (e.g., based on signal transmission times). Further, in another embodiment, a viewer of the computing device 102 may use, for example, a mobile computing device 106 (e.g., a wearable computing device with eye tracking) to facilitate the computing device 102 in determining gaze direction, active interaction region, viewer input selections, and/or other characteristics of the viewer. Of course, relevant data associated with such analyses may be transmitted by the mobile computing device 106 and received by the communication module 208 of the computing device 102.

Referring now to FIGS. 3-4, in use, the computing device 102 may execute a method 300 for displaying viewer interactive content on the display 118 of the computing device 102. The illustrative method 300 begins with block 302 in which the computing device 102 scans for viewers in front of the computing device 102. In other words, the computing device 102 captures one or more images of the scene generally in front of the computing device 102 (i.e., of any persons that may be looking at the display 118) and analyzes those captured images as discussed above to detect any viewers. As indicated above, the computing device 102 may use any suitable technique or algorithm for doing so. For example, the computing device 102 may use blob detection, edge detection, image segmentation, pattern/model matching, and/or other techniques to identify persons (i.e., potential viewers) in front of the computing device 102.

In block 304, the computing device 102 determines whether a viewer has been detected in any of the captured images. If not, the method 300 returns to block 302 in which the computing device 102 continues to scan for potential viewers. However, if a person has been detected, the computing device 102 locates the person's face in a captured image in block 306. To do so, the computing device 102 may use any suitable techniques and/or algorithms (e.g., similar to detecting a person in front of the computing device 102). In block 308, the computing device 102 determines whether the person's face has been detected. If not, the method 300 returns to block 302 in which the computing device 102 continues to scan for potential viewers. In other words, in the illustrative embodiment, the computing device 102 assumes that a person is not a viewer if that person's face cannot be detected in the captured image. For example, a person walking away from the computing device 102, for which a face would not be detected, is unlikely to be looking at the computing device 102. It should be appreciated that, in some embodiments, a potential viewer's head pose direction/orientation may be nonetheless determined to identify, for example, a gaze direction of those viewers (e.g., in a manner similar to that described below). The potential viewers head pose direction/orientation and/or gaze direction may be used to identify where the viewers are actually looking, for example, for future analytical and marketing purposes.

If a viewer's face is detected, the computing device 102 determines the distance range of the viewer relative to the computing device 102 in block 310. As discussed above, the computing device 102 may determine the viewer's distance range as explicit distance values (e.g., three feet, seven feet, twelve feet, etc.) or as an abstract distance range (e.g., short range, medium range, long range, etc.). In some embodiments, the computing device 102 may perform an explicit step of determining the viewer's distance range from the computing device 102. To do so, the computing device 102 may utilize, for example, captured images by one or more cameras of the camera system 120, data collected by the sensors 122 (e.g., distance, depth, or other relevant data), data transmitted from other devices (e.g., the mobile computing device 106), and/or other information. Of course, in other embodiments, the computing device 102 may ascertain or determine the distance range of the viewer from the computing device 102 more implicitly as discussed herein.

It should be appreciated that, in the illustrative embodiment, the distance ranges (e.g., short range, mid-range, and long range) are determined based on the technical limitations of the utilized gaze tracking algorithms and depth camera 128. For example, in particular embodiments, short range (e.g., between zero and four feet from the computing device 102) is defined by the limitations of the implemented gaze tracking technology. In such embodiments, mid-range (e.g., between four and fifteen feet) is defined by the limitations of the utilized depth camera 128 (e.g., the accuracy of the depth stream of images captured by the depth camera 128). Long range (e.g., greater than fifteen feet) may be defined as distances exceeding mid-range distances. Of course, the distance ranges of the viewer may be otherwise determined and may be continuous or discrete depending on the particular embodiment. Accordingly, in block 312, the computing device 102 determines whether the viewer is within gaze tracking distance of the computing device 102 based on the particular implementation and/or technology used to perform such gaze tracking (e.g., within four feet). If so, the computing device 102 determines the viewer's gaze direction based on gaze tracking algorithms in block 314. As discussed above, the computing device 102 may utilize any suitable gaze tracking algorithms for doing so. Further, the computing device 102 may determine a point on the display 118, if any, at which the viewer's gaze is directed as described below.

If the computing device 102 determines that the viewer is not within gaze tracking distance, the computing device 102 determines whether the viewer is within depth determination range in block 316 based on the particular implementation and/or technology used to perform such depth determination. For example, the computing device 102 may determine whether the depth images generated by the depth camera 128 (or analogous data collected by depth sensors) include accurate information as discussed above (e.g., based on an error threshold). If the computing device 102 is within depth determination range, the computing device 102 determines the viewer's head orientation based on an image captured by the depth camera 128 (e.g., an RGB-D image) in block 318. For example, in some embodiments, such an image may be compared to various three-dimensional face templates (e.g., personalized or of a model). Of course, the computing device 102 may analyze the RGB-D image using any suitable techniques or algorithms (e.g., iterative closest point algorithms) for doing so. In some embodiments, determining the viewer's head pose/orientation constitutes determining the roll, pitch, and yaw angles of the viewer's head pose relative to a baseline head orientation (e.g., of a model).

If the computing device 102 determines that the viewer is not within the depth determination range, the computing device 102 determines the viewer's head orientation based on an image captured by the 2D camera 126 in block 320. As discussed above, the computing device 102 may utilize any suitable algorithm or technique for doing so. In some embodiments, the computing device 102 may utilize, for example, an anthropometric 3D model (e.g., a rigid, statistical, shape, texture, and/or other model) in conjunction with a Pose from Orthography and Scaling (POST) or Pose from Orthography and Scaling with Iterations (POSIT) algorithm for head pose/orientation estimation. It should be appreciated that determining the viewer's head orientation may be done using, for example, a static image approach (i.e., based on a single image or multiple images taken at the same time) or a differential or motion-based approach (i.e., based on video or sequences of images) depending on the particular embodiment. Further, in some embodiments, rather than using an image captured by the 2D camera 126, the computing device 102 may analyze the color channels (e.g., RGB portion) of an image captured by the depth camera 128 (e.g., an RGB-D image).

Regardless of whether the computing device 102 determines the viewer's head orientation based on the depth image in block 318 or the 2D image in block 320, the computing device 102 determines the viewer's gaze direction in block 322. In some embodiments, to do so, the computing device 102 further analyzes the corresponding captured image(s) (i.e., the image(s) analyzed in block 314 or block 318) using a suitable algorithm or technique to determine the location of the viewer's eye(s) in the captured images. Further, as discussed above, the computing device 102 may determine various characteristics of the viewer's eyes, which may be used (e.g., in conjunction with the determined orientation of the viewer's head) to determine/estimate the viewer's gaze direction. For example, in an embodiment, a captured image of the viewer's eye may be compared to a set of reference images indicative of different eye orientations (or gaze directions) of a person relative to the person's face. In such an embodiment, a reference/model image of an eye of a person looking up may show a portion of the person's sclera (i.e., white of the eye) at the bottom of the reference image and a portion of the person's iris toward the top of the reference image. Similarly, a reference image of a person looking directly forward may show the person's iris and pupil with the sclera at both sides of the iris. Additionally, a reference image of a person looking down may predominantly show, for example, the sclera and/or the person's upper eyelid toward the top of the reference image. Of course, the set of reference images used may vary in number and orientation and may depend, for example, on the determined orientation of the viewer's head (e.g., an eye of a person looking down with her head pointed toward a camera may look different than the eye of a person looking to the side).

In the illustrative embodiment, the computing device 102 determines the viewer's gaze direction with respect to the display 118 based on the viewer's head orientation, the viewer's eye orientation, and/or the determined distance range of the viewer from the computing device 102. In particular, in some embodiments, the computing device 102 may determine the angles of a vector (i.e., a gaze vector) in three-dimensional space directed from the viewer's eye and coincident with the viewer's gaze. Further, in some embodiments, the computing device 102 determines a point or region on the display 118 at which the viewer's gaze is directed. It should be appreciated that the computing device 102 may make such a determination using any suitable algorithms and/or techniques for doing so. For example, in some embodiments, the computing device 102 may store data indicative of the relative locations of the components of the computing device 102 (e.g., the display 118, the camera system 120, the sensors 122, individual cameras, and/or other components) to one another and/or to a fixed point (i.e., an origin) in two-dimensional or three-dimensional space. Based on such a coordinate system, the distance range of the viewer to the computing device 102, and the relative orientation of the viewer's gaze (e.g., gaze angles based on the viewer's head and/or eye orientations), the computing device 102 may determine the point/region on the display 118 at which the viewer's gaze is directed. In another embodiment, the computing device 102 may extend the gaze vector of the viewer to a plane coincident with the display 118 and identify the point of intersection between the gaze vector and the plane as such a point. Of course, in some circumstances, the computing device 102 may determine that the viewer is not looking directly at any point on the display 118 and handle those circumstances accordingly. For example, the computing device 102 may ignore the viewer or identify a point on the display 118 in which to attribute the viewer's gaze (e.g., a point on the display 118 nearest the viewer's actual gaze vector).

Regardless of whether the computing device 102 determines the viewer's gaze direction based on a gaze tracking algorithm as described in block 314 or as described in block 322, the method 300 advances to block 324 of FIG. 4 in which the computing device 102 determines an active interaction region of the display 118 based on the viewer's gaze direction and/or the distance range of the viewer from the computing device 102. As discussed above, the computing device 102 may determine a point or region (i.e., a physical location) on the display 118 at which the viewer's gaze is directed (or a point to which the viewer's gaze is attributed). As such, in block 326, the computing device 102 determines a location of the active interaction region based on the viewer's gaze direction. For example, in some embodiments, the location of the active interaction region of the display 118 may be centered about, be oriented around, or be otherwise associated with or include the point at which the viewer's gaze is directed. In block 328, the computing device 102 also determines the size of the active interaction region. In the illustrative embodiment, the size of the active interaction region is dependent on the distance range of the viewer from the computing device 102. As discussed above, the size of the active interaction region is reduced (e.g., about the viewer's gaze point) as the viewer approaches the computing device 102. That is, the active interaction region may be smaller if the viewer is a short distance from the computing device 102 than if the viewer is a long distance from the computing device 102, despite the viewer's gaze being directed to the same point. In other words, as discussed above, the computing device 102 may dynamically determine the size and location of the active interaction region based on the viewer's gaze direction and the distance range of the viewer from the computing device 102. Of course, in some embodiments, the computing device 102 may determine the active interaction region of the display 118 based on only one of the viewer's gaze direction or the distance range of the viewer from the computing device 102.

In block 330, the computing device 102 determines whether to detect another viewer. If so, the method 300 returns to block 302 of FIG. 3 in which the computing device 102 scans for additional viewers in front of the computing device 102. In other words, in the illustrative embodiment, the computing device 102 may be configured for use by multiple viewers. In such embodiments, the active interaction region may be determined in singular or plural and may be determined based on the gaze directions and distance ranges of the several viewers. Of course, in some embodiments, the method 300 may be implemented for use with a single viewer.

If the computing device 102 determines not to detect another viewer or the computing device 102 is implemented for use based on only one viewer's gaze, the computing device 102 displays content based on the identified active interaction region(s) of the viewer(s) in block 332. As discussed above, the display 118 may be virtually divided into one or more active interaction regions and passive interaction regions. Further, a viewer's gaze at a particular point in the active interaction region of the display 118 may be indicative of a desired input selection of a display element shown at that point. Accordingly, the computing device 102 may display content (e.g., in the active and/or passive interaction regions) based on the viewer's input selection. For example, in some embodiments, the computing device 102 may display primary content (i.e., content directly related to a user input) in or around the active interaction region and other content (e.g., background images or previously shown content) in the passive interaction region. In block 334, the computing device 102 may store data regarding the determined gaze directions of the viewers, the determined active interaction regions, and/or other information useful for the operation of the computing device 102 and/or for future marketing purposes (e.g., for data mining). The method 300 returns to block 302 of FIG. 3 in which the computing device 102 scans for viewers. It should be appreciated that, in some embodiments, the method 300 may be performed in a loop to continuously determine the gaze direction of viewers' and display appropriate content on the display 118.

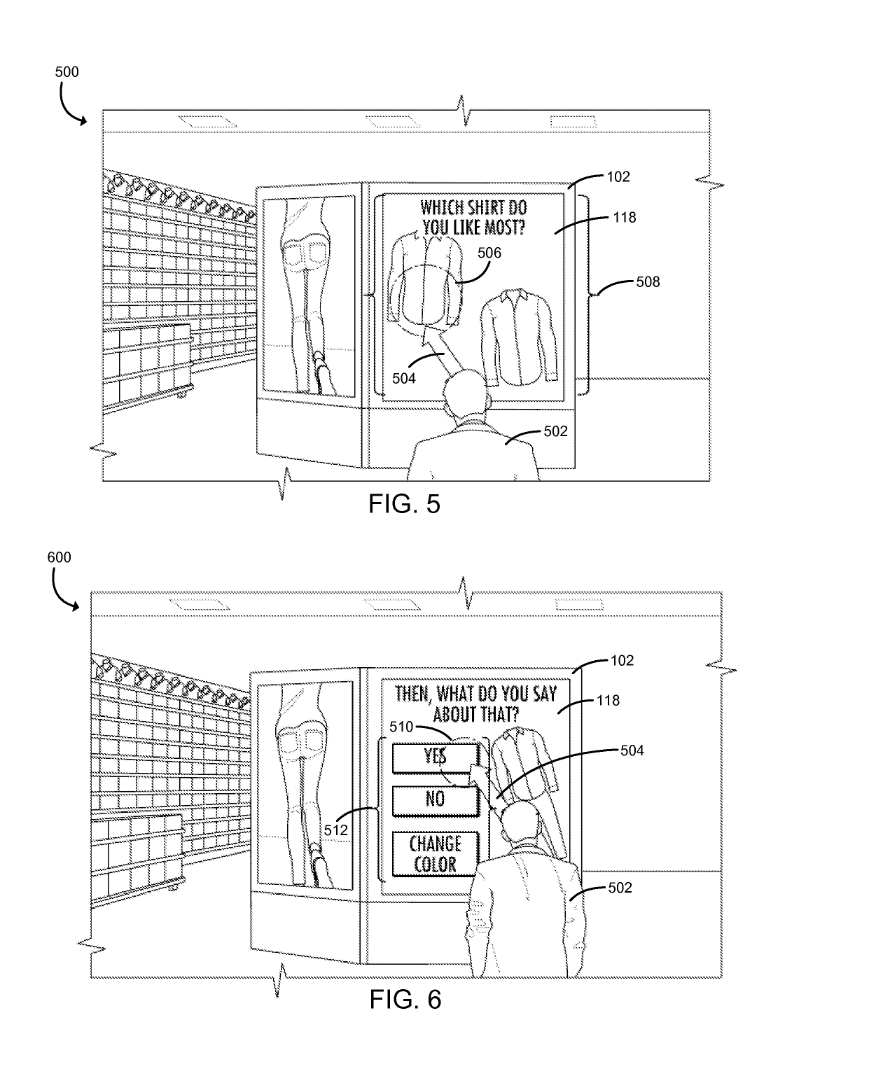

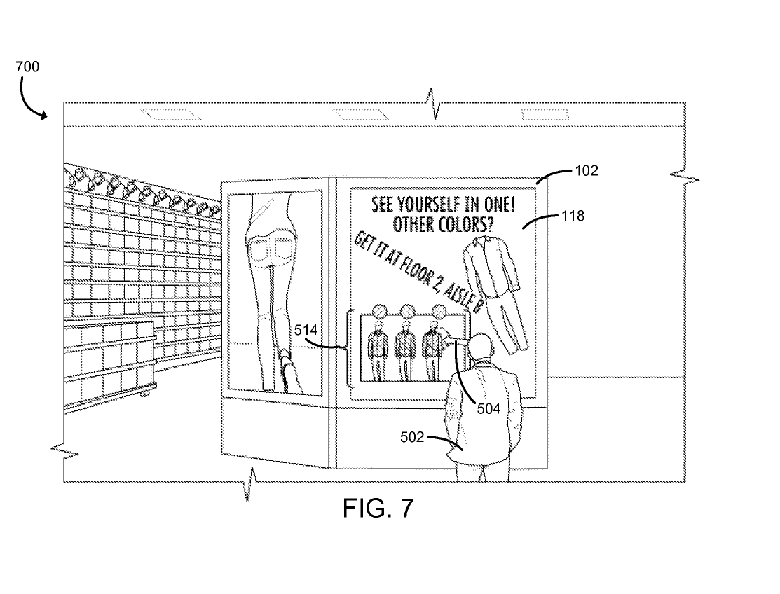

Referring now to FIGS. 5-7, simplified illustrations of a viewer 502 interacting with the computing device 102 are shown. It should be appreciated that, in the illustrative usage scenario shown in FIGS. 5-7, the computing device 102 is embodied as an interactive digital sign. Additionally, in the scenario, the viewer 502 is farther from the computing device 102 in FIG. 6 than in FIG. 7 and farther from the computing device 102 in FIG. 5 than in FIG. 6. In other words, in the sequence of FIGS. 5-7, the viewer 502 is walking toward the computing device 102. As shown in FIG. 5, two shirts are shown on the display 118 and the viewer's gaze is directed to a particular region 506 of the display 118 of the computing device 102. Accordingly, as described above, the computing device 102 determines the viewer's gaze direction 504 and the distance range of the viewer 502 from the computing device 102 and, based on those determinations, an active interaction region 508 of the display 118. The computing device 102 associates the viewer's gaze direction 504 (or the corresponding point within the active interaction region 508) with a desired input selection and displays different content on the display 118 as shown in FIG. 6. In particular, the computing device 102 displays the selected shirt as part of an outfit with a query, “Then, what do you say about that?” with a list of input selections. As shown, the viewer's gaze is directed to a region 510 of the display 118. Similar to that described above, the computing device 102 determines the viewer's new gaze direction 504 and the new distance range of the viewer 502 from the computing device 102 and, based on those determinations, an active interaction region 512 of the display 118. It should be appreciated that the active interaction region 512 is smaller than the active interaction region 508 because the viewer 502 is closer to the computing device 102. The computing device 102 associates the viewer's gaze direction 504 with an input selection, “Yes,” and displays the previously displayed outfit in three different colors on the display 118 as shown in FIG. 7. As described above, the computing device 102 determines the viewer's new gaze direction 504, distance range, and active interaction region 514 and determines the content for display as described above.

### Examples

Illustrative examples of the technologies disclosed herein are provided below. An embodiment of the technologies may include any one or more, and any combination of, the examples described below.

Example 1 includes a computing device for viewer attention area estimation, the computing device comprising a display; a camera system to capture an image of a viewer of the display; an attention region estimation module to (i) determine a distance range of the viewer from the computing device, (ii) determine a gaze direction of the viewer based on the captured image and the distance range of the viewer, and (iii) determine an active interaction region of the display based on the viewer's gaze direction and the distance range of the viewer; and a display module to display content on the display based on the determined active interaction region.

Example 2 includes the subject matter of Example 1, and wherein to determine the distance range of the viewer comprises to determine the distance range of the viewer based on the captured image of the viewer.

Example 3 includes the subject matter of any of Examples 1 and 2, and where to determine the distance range of the viewer comprises to determine the distance range of the viewer in response to detection of a face of the viewer in the captured image.

Example 4 includes the subject matter of any of Examples 1-3, and wherein to determine the distance range of the viewer comprises to determine whether the viewer is within a first distance at which a gaze tracking algorithm can accurately determine the viewer's gaze direction within a first threshold level of error; and determine whether the viewer is within a second distance, greater than the first distance, at which the depth camera can accurately measure depth within a second threshold level of error.

Example 5 includes the subject matter of any of Examples 1-4, and wherein to determine the distance range of the viewer comprises to determine whether a distance of the viewer from the computing device exceeds a first threshold distance; and determine whether the distance of the viewer from the computing device exceeds a second threshold distance greater than the first threshold distance if the distance of the viewer from the computing device exceeds the first threshold distance.

Example 6 includes the subject matter of any of Examples 1-5, and wherein the distance range of the viewer is one of (i) a short range from the computing device, (ii) a mid-range from the computing device, or (iii) a long range from the computing device.

Example 7 includes the subject matter of any of Examples 1-6, and wherein the camera system comprises a two-dimensional camera to capture the image of the viewer, the image of the viewer being a first image; and a depth camera to capture a second image of the viewer.

Example 8 includes the subject matter of any of Examples 1-7, and wherein to determine the viewer's gaze direction comprises to determine the viewer's gaze direction based on the first captured image in response to a determination that the distance range is a long range from computing device; determine the viewer's gaze direction based on the second captured image in response to a determination that the distance range is a mid-range from the computing device; and determine the viewer's gaze direction based on a gaze tracking algorithm in response to a determination that the distance range is a short range from the computing device.

Example 9 includes the subject matter of any of Examples 1-8, and wherein to determine the viewer's gaze direction based on the second captured image comprises to determine the viewer's head orientation based on the second captured image.

Example 10 includes the subject matter of any of Examples 1-9, and wherein the two-dimensional camera comprises a red-green-blue (RGB) camera and the depth camera comprises a red-green-blue-depth (RGB-D) camera, and wherein to determine the viewer's gaze direction based on the first captured image comprises to determine the viewer's gaze direction based on an analysis of an RGB image; and determine the viewer's gaze direction based on the second captured image comprises to determine the viewer's gaze direction based on an analysis of an RGB-D image.

Example 11 includes the subject matter of any of Examples 1-10, and wherein to determine the active interaction region comprises to determine an active interaction region having (i) a size that is a function of the distance range of the viewer and (ii) a location that is a function of the viewer's gaze direction.

Example 12 includes the subject matter of any of Examples 1-11, and wherein the viewer's gaze direction is indicative of a desired input selection of the viewer to the computing device; and wherein to display content on the display comprises to display content based on the viewer's input selection.

Example 13 includes the subject matter of any of Examples 1-12, and wherein to capture the image of the viewer comprises to capture an image of a plurality of viewers; determine the distance range of the viewer comprises to determine a corresponding distance range of each of the plurality of viewers from the computing device; determine the viewer's gaze direction comprises to determine a corresponding gaze direction of each of the plurality of viewers; and determine the active interaction region of the display comprises to determine a corresponding active interaction region of the display for each of the plurality of viewers based on the corresponding gaze direction of each of the plurality of viewers and the corresponding distance range of each of the plurality of viewers.

Example 14 includes the subject matter of any of Examples 1-13, and wherein to display the content on the display comprises to display content on the display based on the active interaction regions determined for each of the plurality of viewers.

Example 15 includes the subject matter of any of Examples 1-14, and wherein the computing device is embodied as an interactive digital sign.

Example 16 includes a method for viewer attention area estimation by a computing device, the method comprising capturing, by a camera system of the computing device, an image of a viewer of a display of the computing device; determining, by the computing device, a distance range of the viewer from the computing device; determining, by the computing device, a gaze direction of the viewer based on the captured image and the distance range of the viewer; determining, by the computing device, an active interaction region of the display based on the viewer's gaze direction and the distance range of the viewer, wherein the active interaction region is indicative of a region of the display at which the viewer's gaze is directed; and displaying content on the display based on the determined active interaction region.

Example 17 includes the subject matter of Example 16, and wherein determining the distance range of the viewer comprises determining the distance range of the viewer based on the captured image of the viewer.

Example 18 includes the subject matter of any of Examples 16 and 17, and wherein determining the distance range of the viewer comprises determining the distance range of the viewer in response to detecting a face of the viewer in the captured image.

Example 19 includes the subject matter of any of Examples 16-18, and wherein determining the distance range of the viewer comprises determining whether the viewer is within a first distance at which a gaze tracking algorithm can accurately determine the viewer's gaze direction within a first threshold level of error; and determining whether the viewer is within a second distance, greater than the first distance, at which the depth camera can accurately measure depth within a second threshold level of error.

Example 20 includes the subject matter of any of Examples 16-19, and wherein determining the distance range of the viewer comprises determining whether a distance of the viewer from the computing device exceeds a first threshold distance; and determining whether the distance of the viewer from the computing device exceeds a second threshold distance greater than the first threshold distance if the distance of the viewer from the computing device exceeds the first threshold distance.

Example 21 includes the subject matter of any of Examples 16-20, and wherein determining the distance range of the viewer comprises determining that the viewer is (i) a short range from the computing device, (ii) a mid-range from the computing device, or (iii) a long range from the computing device.

Example 22 includes the subject matter of any of Examples 16-21, and wherein capturing the image of the viewer comprises capturing a first image of the viewer with a two-dimensional camera of the camera system, and further comprising capturing, by a depth camera of the camera system, a second image of the viewer.

Example 23 includes the subject matter of any of Examples 16-22, and wherein determining the viewer's gaze direction comprises determining the viewer's gaze direction based on the first captured image in response to determining that the distance range is a long range from the computing device; determining the viewer's gaze direction based on the second captured image in response to determining that the distance range is a mid-range from the computing device; and determining the viewer's gaze direction based on a gaze tracking algorithm in response to determining that the distance range is a short range from the computing device.

Example 24 includes the subject matter of any of Examples 16-23, and wherein determining the viewer's gaze direction based on the second captured image comprises determining the viewer's head orientation based on the second captured image.

Example 25 includes the subject matter of any of Examples 16-24, and wherein the two-dimensional camera comprises a red-green-blue (RGB) camera and the depth camera comprises a red-green-blue-depth (RGB-D) camera, and wherein determining the viewer's gaze direction based on the first captured image comprises determining the viewer's gaze direction based on an analysis of an RGB image; and determining the viewer's gaze direction based on the second captured image comprises determining the viewer's gaze direction based on an analysis of an RGB-D image.

Example 26 includes the subject matter of any of Examples 16-25, and wherein determining the active interaction region comprises determining an active interaction region having (i) a size that is a function of the distance range of the viewer and (ii) a location that is a function of the viewer's gaze direction.

Example 27 includes the subject matter of any of Examples 16-26, and wherein the viewer's gaze direction is indicative of a desired input selection of the viewer to the computing device; and displaying content on the display comprises displaying content based on the viewer's input selection.

Example 28 includes the subject matter of any of Examples 16-27, and wherein capturing the image of the viewer comprises capturing an image of a plurality of viewers; determining the distance range of the viewer comprises determining a corresponding distance range of each of the plurality of viewers from the computing device; determining the viewer's gaze direction comprises determining a corresponding gaze direction of each of the plurality of viewers; and determining the active interaction region of the display comprises determining a corresponding active interaction region of the display for each of the plurality of viewers based on the corresponding gaze direction of each of the plurality of viewers and the corresponding distance range of each of the plurality of viewers.

Example 29 includes the subject matter of any of Examples 16-28, and wherein displaying the content on the display comprises displaying content on the display based on the active interaction regions determined for each of the plurality of viewers.

Example 30 includes the subject matter of any of Examples 16-29, and wherein the computing device is embodied as an interactive digital sign.

Example 31 includes a computing device comprising a processor; and a memory having stored therein a plurality of instructions that when executed by the processor cause the computing device to perform the method of any of Examples 16-30.

Example 32 includes one or more machine-readable storage media comprising a plurality of instructions stored thereon that, in response to being executed, result in a computing device performing the method of any of Examples 16-30.

Example 33 includes a computing device for viewer attention area estimation, the computing device comprising means for capturing, by a camera system of the computing device, an image of a viewer of a display of the computing device; means for determining a distance range of the viewer from the computing device; means for determining a gaze direction of the viewer based on the captured image and the distance range of the viewer; means for determining an active interaction region of the display based on the viewer's gaze direction and the distance range of the viewer, wherein the active interaction region is indicative of a region of the display at which the viewer's gaze is directed; and means for displaying content on the display based on the determined active interaction region.

Example 34 includes the computing device of Example 33, and wherein the means for determining the distance range of the viewer comprises means for determining the distance range of the viewer based on the captured image of the viewer.

Example 35 includes the computing device of any of Examples 33 and 34, and where the means for determining the distance range of the viewer comprises means for determining the distance range of the viewer in response to detecting a face of the viewer in the captured image.

Example 36 includes the computing device of any of Examples 33-35, and wherein the means for determining the distance range of the viewer comprises means for determining whether the viewer is within a first distance at which a gaze tracking algorithm can accurately determine the viewer's gaze direction within a first threshold level of error; and means for determining whether the viewer is within a second distance, greater than the first distance, at which the depth camera can accurately measure depth within a second threshold level of error.

Example 37 includes the computing device of any of Examples 33-36, and wherein the means for determining the distance range of the viewer comprises means for determining whether a distance of the viewer from the computing device exceeds a first threshold distance; and means for determining whether the distance of the viewer from the computing device exceeds a second threshold distance greater than the first threshold distance if the distance of the viewer from the computing device exceeds the first threshold distance.

Example 38 includes the computing device of any of Examples 33-37, and wherein the means for determining the distance range of the viewer comprises means for determining that the viewer is (i) a short range from the computing device, (ii) a mid-range from the computing device, or (iii) a long range from the computing device.

Example 39 includes the computing device of any of Examples 33-38, and wherein the means for capturing the image of the viewer comprises means for capturing a first image of the viewer with a two-dimensional camera of the camera system, and further comprising means for capturing, by a depth camera of the camera system, a second image of the viewer.

Example 40 includes the computing device of any of Examples 33-39, and wherein the means for determining the viewer's gaze direction comprises means for determining the viewer's gaze direction based on the first captured image in response to determining that the distance range is a long range from the computing device; means for determining the viewer's gaze direction based on the second captured image in response to determining that the distance range is a mid-range from the computing device; and means for determining the viewer's gaze direction based on a gaze tracking algorithm in response to determining that the distance range is a short range from the computing device.

Example 41 includes the computing device of any of Examples 33-40, and wherein the means for determining the viewer's gaze direction based on the second captured image comprises means for determining the viewer's head orientation based on the second captured image.

Example 42 includes the computing device of any of Examples 33-41, and wherein the two-dimensional camera comprises a red-green-blue (RGB) camera; the depth camera comprises a red-green-blue-depth (RGB-D) camera; the means for determining the viewer's gaze direction based on the first captured image comprises means for determining the viewer's gaze direction based on an analysis of an RGB image; and the means for determining the viewer's gaze direction based on the second captured image comprises means for determining the viewer's gaze direction based on an analysis of an RGB-D image.

Example 43 includes the computing device of any of Examples 33-42, and wherein the means for determining the active interaction region comprises means for determining an active interaction region having (i) a size that is a function of the distance range of the viewer and (ii) a location that is a function of the viewer's gaze direction.

Example 44 includes the computing device of any of Examples 33-43, and wherein the viewer's gaze direction is indicative of a desired input selection of the viewer to the computing device; and the means for displaying content on the display comprises means for displaying content based on the viewer's input selection.

Example 45 includes the computing device of any of Examples 33-44, and wherein the means for capturing the image of the viewer comprises means for capturing an image of a plurality of viewers; the means for determining the distance range of the viewer comprises means for determining a corresponding distance range of each of the plurality of viewers from the computing device; the means for determining the viewer's gaze direction comprises means for determining a corresponding gaze direction of each of the plurality of viewers; and the means for determining the active interaction region of the display comprises means for determining a corresponding active interaction region of the display for each of the plurality of viewers based on the corresponding gaze direction of each of the plurality of viewers and the corresponding distance range of each of the plurality of viewers.

Example 46 includes the computing device of any of Examples 33-45, and wherein the means for displaying the content on the display comprises means for displaying content on the display based on the active interaction regions determined for each of the plurality of viewers.

Example 47 includes the computing device of any of Examples 33-46, and wherein the computing device is embodied as an interactive digital sign.

1. A computing device for viewer attention area estimation, the computing device comprising:
a display;
a camera system to capture an image of a viewer of the display;
an attention region estimation module to (i) determine a distance range of the viewer from the computing device, (ii) determine a gaze direction of the viewer based on the captured image and the distance range of the viewer, and (iii) determine an active interaction region of the display based on the viewer's gaze direction and the distance range of the viewer; and
a display module to display content on the display based on the determined active interaction region.

2. The computing device of claim 1, where to determine the distance range of the viewer comprises to determine the distance range of the viewer in response to detection of a face of the viewer in the captured image.

3. The computing device of claim 1, wherein to determine the distance range of the viewer comprises to:
determine whether the viewer is within a first distance at which a gaze tracking algorithm can accurately determine the viewer's gaze direction within a first threshold level of error; and
determine whether the viewer is within a second distance, greater than the first distance, at which the depth camera can accurately measure depth within a second threshold level of error.

4. The computing device of claim 1, wherein to determine the distance range of the viewer comprises to:
determine whether a distance of the viewer from the computing device exceeds a first threshold distance; and
determine whether the distance of the viewer from the computing device exceeds a second threshold distance greater than the first threshold distance if the distance of the viewer from the computing device exceeds the first threshold distance.

5. The computing device of claim 1, the distance range of the viewer comprises is one of (i) a short range from the computing device, (ii) a mid-range from the computing device, or (iii) a long range from the computing device.

6. The computing device of claim 1, wherein the camera system comprises (i) a two-dimensional camera to capture the image of the viewer, the image of the viewer being a first image, and (ii) a depth camera to capture a second image of the viewer, and wherein to determine the viewer's gaze direction comprises to:
determine the viewer's gaze direction based on the first captured image in response to a determination that the distance range is a long range from the computing device;
determine the viewer's gaze direction based on the second captured image in response to a determination that the distance range is a mid-range from the computing device; and
determine the viewer's gaze direction based on a gaze tracking algorithm in response to a determination that the distance range is a short range from the computing device.

7. The computing device of claim 6, wherein to determine the viewer's gaze direction based on the second captured image comprises to determine the viewer's head orientation based on the second captured image.

8. The computing device of claim 6, wherein the two-dimensional camera comprises a red-green-blue (RGB) camera and the depth camera comprises a red-green-blue-depth (RGB-D) camera, and wherein to:
determine the viewer's gaze direction based on the first captured image comprises to determine the viewer's gaze direction based on an analysis of an RGB image; and
determine the viewer's gaze direction based on the second captured image comprises to determine the viewer's gaze direction based on an analysis of an RGB-D image.

9. The computing device of claim 1, wherein to determine the active interaction region comprises to determine an active interaction region having (i) a size that is a function of the distance range of the viewer and (ii) a location that is a function of the viewer's gaze direction.

10. The computing device of claim 9, wherein the viewer's gaze direction is indicative of a desired input selection of the viewer to the computing device; and
wherein to display content on the display comprises display content based on the viewer's input selection.

11. The computing device of claim 1, wherein to:
capture the image of the viewer comprises to capture an image of a plurality of viewers;
determine the distance range of the viewer comprises to determine a corresponding distance range of each of the plurality of viewers from the computing device;
determine the viewer's gaze direction comprises to determine a corresponding gaze direction of each of the plurality of viewers; and
determine the active interaction region of the display comprises to determine a corresponding active interaction region of the display for each of the plurality of viewers based on the corresponding gaze direction of each of the plurality of viewers and the corresponding distance range of each of the plurality of viewers.

12. The computing device of claim 11, wherein to display the content on the display comprises to display content on the display based on the active interaction regions determined for each of the plurality of viewers.

13. One or more machine-readable storage media comprising a plurality of instructions stored thereon that, in response to execution by a computing device, cause the computing device to:
capture, by a camera system of the computing device, an image of a viewer of a display of the computing device;
determine a distance range of the viewer from the computing device;
determine a gaze direction of the viewer based on the captured image and the distance range of the viewer;
determine an active interaction region of the display based on the viewer's gaze direction and the distance range of the viewer, wherein the active interaction region is indicative of a region of the display at which the viewer's gaze is directed; and
display content on the display based on the determined active interaction region.

14. The one or more machine-readable storage media of claim 13, wherein to determine the distance range of the viewer comprises to:
determine whether the viewer is within a first distance at which a gaze tracking algorithm can accurately determine the viewer's gaze direction within a first threshold level of error; and
determine whether the viewer is within a second distance, greater than the first distance, at which the depth camera can accurately measure depth within a second threshold level of error.

15. The one or more machine-readable storage media of claim 13, wherein to determine the distance range of the viewer comprises to:
determine whether a distance of the viewer from the computing device exceeds a first threshold distance; and
determine whether the distance of the viewer from the computing device exceeds a second threshold distance greater than the first threshold distance if the distance of the viewer from the computing device exceeds the first threshold distance.

16. The one or more machine-readable storage media of claim 13, wherein to determine the distance range of the viewer comprises to determine that the viewer is (i) a short range from the computing device, (ii) a mid-range from the computing device, or (iii) a long range from the computing device.

17. The one or more machine-readable storage media of claim 13, wherein to capture the image of the viewer comprises to capture a first image of the viewer with a two-dimensional camera of the camera system; and
wherein the plurality of instructions further cause the computing device to capture, by a depth camera of the camera system, a second image of the viewer.

18. The one or more machine-readable storage media of claim 17, wherein to determine the viewer's gaze direction comprises to:
determine the viewer's gaze direction based on the first captured image in response to a determination that the distance range is a long range from the computing device;
determine the viewer's gaze direction based on the second captured image in response to a determination that the distance range is a mid-range from the computing device; and
determine the viewer's gaze direction based on a gaze tracking algorithm in response to a determination that the distance range is a short range from the computing device.

19. The one or more machine-readable storage media of claim 18, wherein to determine the viewer's gaze direction based on the second captured image comprises to determine the viewer's head orientation based on the second captured image.

20. The one or more machine-readable storage media of claim 18, wherein the two-dimensional camera comprises a red-green-blue (RGB) camera and the depth camera comprises a red-green-blue-depth (RGB-D) camera, and wherein to:
determine the viewer's gaze direction based on the first captured image comprises to determine the viewer's gaze direction based on an analysis of an RGB image; and
determine the viewer's gaze direction based on the second captured image comprises to determine the viewer's gaze direction based on an analysis of an RGB-D image.

21. The one or more machine-readable storage media of claim 13, wherein to determine the active interaction region comprises to determine an active interaction region having (i) a size that is a function of the distance range of the viewer and (ii) a location that is a function of the viewer's gaze direction.

22. The one or more machine-readable storage media of claim 13, wherein to:
capture the image of the viewer comprises to capture an image of a plurality of viewers;
determine the distance range of the viewer comprises to determine a corresponding distance range of each of the plurality of viewers from the computing device;
determine the viewer's gaze direction comprises to determine a corresponding gaze direction of each of the plurality of viewers; and
determine the active interaction region of the display comprises to determine a corresponding active interaction region of the display for each of the plurality of viewers based on the corresponding gaze direction of each of the plurality of viewers and the corresponding distance range of each of the plurality of viewers.

23. A method for viewer attention area estimation by a computing device, the method comprising:
capturing, by a camera system of the computing device, an image of a viewer of a display of the computing device;
determining, by the computing device, a distance range of the viewer from the computing device;
determining, by the computing device, a gaze direction of the viewer based on the captured image and the distance range of the viewer;
determining, by the computing device, an active interaction region of the display based on the viewer's gaze direction and the distance range of the viewer, wherein the active interaction region is indicative of a region of the display at which the viewer's gaze is directed; and
displaying content on the display based on the determined active interaction region.

24. The method of claim 23, wherein capturing the image of the viewer comprises capturing a first image of the viewer with a two-dimensional camera of the camera system, further comprising capturing, by a depth camera of the camera system, a second image of the viewer, and wherein determining the viewer's gaze direction comprises:
determining the viewer's gaze direction based on the first captured image in response to determining that the distance range is a long range from the computing device;
determining the viewer's gaze direction based on the second captured image in response to determining that the distance range is a mid-range from the computing device; and
determining the viewer's gaze direction based on a gaze tracking algorithm in response to determining that the distance range is a short range from the computing device.

25. The method of claim 23, wherein determining the active interaction region comprises determining an active interaction region having (i) a size that is a function of the distance range of the viewer and (ii) a location that is a function of the viewer's gaze direction.
